(19) United States
(12) Patent Application Publication
(10) Pub. No.: US 2021/0233200 A1
(43) Pub. Date: Jul. 29, 2021

(54) DISTRIBUTED LEDGER BASED DISTRIBUTED GAMING SYSTEM

(71) Applicant: SpoonRead Inc., Capitola, CA (US)

(72) Inventors: Bart Alan Meltzer, Corralitos, CA (US); Mayank V. Vadodaria, Cupertino, CA (US)

(73) Assignee: SpoonRead Inc., Capitola, CA (US)

(21) Appl. No.: 16/832,759

(22) Filed: Mar. 27, 2020

Related U.S. Application Data
(60) Provisional application No. 62/965,153, filed on Jan. 23, 2020.

(51) Int. Cl. G06Q 50/34; G06F 21/62; G06Q 20/36; G06Q 20/38; G06Q 20/06; G06Q 20/40; G06Q 50/26; G06Q 40/02; G06F 16/27; G06F 16/23; G06F 9/54; H04L 9/32; H04L 9/14; G07F 17/32

(52) U.S. Cl. CPC G06Q 50/34; G06Q 2220/00; G06Q 20/3674; G06Q 20/3829; G06Q 20/3672; G06Q 20/385; G06Q 20/0655; G06Q 20/4016; G06Q 50/265; G06Q 40/02; G06F 16/27; G06F 16/2379; G06F 9/54; H04L 9/3213; H04L 9/14; G07F 17/3241; G06F 21/6218

(57) ABSTRACT

The technology teaches a distributed gaming system, comprising a server side node configured to administer transactions for a gambling casino, selling and redeeming chips using a private database, and recording transactions on a distributed ledger using crypto-tokens for a house account having a unique identifier and private key. Administrator wallet tracks transactions on the ledger, maintaining customer and dealer accounts, each with unique identifiers and private keys, and executes API with client side nodes. Customer wallets track transactions on ledger. Dealer wallets track transactions on ledger and accept messages indicating confirmation of payment by customer and transfer of tokens from administrator wallet to customer wallet, accepts messages indicating confirmation of delivery of chips from dealer to customer and transfer of tokens from customer wallet to administrator wallet, and accepts messages confirming delivery of chips from customer to dealer and transfer of tokens from administrator wallet to customer wallet.

### PRIORITY APPLICATION

This application claims the benefit of U.S. Provisional Patent Application No. 62/965,153 filed 23 Jan. 2020; which application is incorporated herein by reference.

### BACKGROUND

### Technological Field

The present invention generally relates to the field of gaming casinos and in particular to a framework of tools improving technology used for interactions between gaming customers and the gaming casino house.

### Description of Related Art

Casinos are an area of business with a focus on luxury and pampering of guests and customers as they come and go. With this focus on customer experience, it makes sense to give those visiting the casino what they need right at their fingertips with concierge apps that act as a virtual best friend for customers staying and playing at a casino.

A blockchain network is a decentralized and distributed system that hosts electronic ledgers that can record transactions efficiently and in a verifiable and permanent way. The electronic ledgers comprise blocks of transactions and other information pertinent to the blocks. Transactions can encode for example, transfers of control of tokens between participants in the blockchain network. Each block contains a cryptographic hash of the previous block, thereby creating a chain of blocks or a “blockchain.” Blockchain is an append-only linear transactional database. Examples of popular blockchain platforms include Ethereum™, Eris™, MultiChain™, Bitcoin™, Hyperledger Fabric™, Credo Blockchain™, and Hyperledger Corda™.

It is desirable to provide improvements in technology than can manage transactions between a customer and a gaming house without using cash, while safely providing for redemption of non cash tokens into fiat, and establishing immutable records of non-cash transactions available to provide transparency and trust in the network.

### SUMMARY

A technology is described herein that includes a method of administering transactions for a gambling casino in a distributed gaming system, including selling chips and redeeming chips using a private database, comprising recording at least some of the transactions on a distributed ledger using crypto-tokens, including one or more administrator wallets, each having a unique house identifier and private key to track transactions on the distributed ledger that include the unique house identifier. The method also includes maintaining user accounts for customers including customer wallets having unique customer identifiers and private keys to track transactions on the distributed ledger that include the unique customer identifiers and maintaining dealer accounts for dealers. The method further includes executing an application program interface (API) with client side nodes, the API having procedures for accepting token purchase messages indicating confirmation of fiat attributed to the user account for a particular customer and in response transferring tokens from an administrator wallet to a customer wallet. The method additionally includes accepting chip purchase messages indicating confirmation of delivery of chips from a dealer account to an identified user account, and in response transferring tokens from the customer wallet of the identified user account to one of the one or more administrator wallets and recording the purchase of chips in the private database. The method also includes accepting redemption messages indicating confirmation of delivery of chips attributed to the user account for a particular customer to a dealer account, and in response transferring tokens from the customer wallet of the identified user account to one of the one or more administrator wallets and recording the redemption of chips in the private database.

The technology disclosed also includes a computer system having one or more network nodes, configured to execute a set of procedures for establishing and maintaining accounts and for executing the methods described herein.

The technology disclosed also includes a computer program product storing a computer program on non-transitory memory, which when executed at one or more network nodes, executes a set of procedures for establishing and maintaining accounts and other the methods described herein.

Other aspects and advantages of the present technology can be seen on review of the drawings, the detailed description and the claims, which follow.

### BRIEF DESCRIPTION OF THE DRAWINGS

FIG. 1 is a network perspective of a distributed gaming system for administering transactions for a gambling casino including selling chips and redeeming chips using a private database, as described herein.

FIG. 2 illustrates system interactions that support the distributed gaming system described herein.

FIG. 3A shows a block diagram for customer app in an embodiment described herein.

FIG. 3B shows a block diagram for dealer app in an embodiment described herein.

FIG. 4 shows a block diagram for management system configured to administer transactions for the distributed gaming system, in an embodiment described herein.

FIG. 5 constitutes a relationship diagram for data structures maintained in support of the distributed gaming system for administering transactions for a gambling casino including selling chips and redeeming chips using a private database, as described herein.

FIG. 6A through FIG. 6D illustrate the field entries for a representative subset of data structures that are utilized relative to customer apps and wallets, and pit boss apps and wallets, related as shown in FIG. 5.

FIG. 6A shows a representative set of fields for user table with primary key which links the user to the record with contact information.

FIG. 6B illustrates a representative organization of data fields for additional information about the user.

FIG. 6C illustrates a representative organization for an Ethereum wallet data structure.

FIG. 6D illustrates a representative organization for a merchant data structure.

FIG. 7A shows a representative customer wallet user interface.

FIG. 7B shows a representative dealer wallet user interface.

FIG. 8 is a simplified flowchart of a procedure for administering transactions for a gambling casino in a distributed gaming system, including selling chips and redeeming chips using a private database, with the support of the server and the administrator application.

FIG. 9 illustrates the flowchart for enabling supervisor apps administering transactions for a gambling casino to authenticate and authorize client side nodes

FIG. 10 is a simplified diagram of a hardware platform which is configured for a distributed gaming system for administering transactions for a gambling casino including selling chips and redeeming chips using a private database, as described herein.

### DETAILED DESCRIPTION

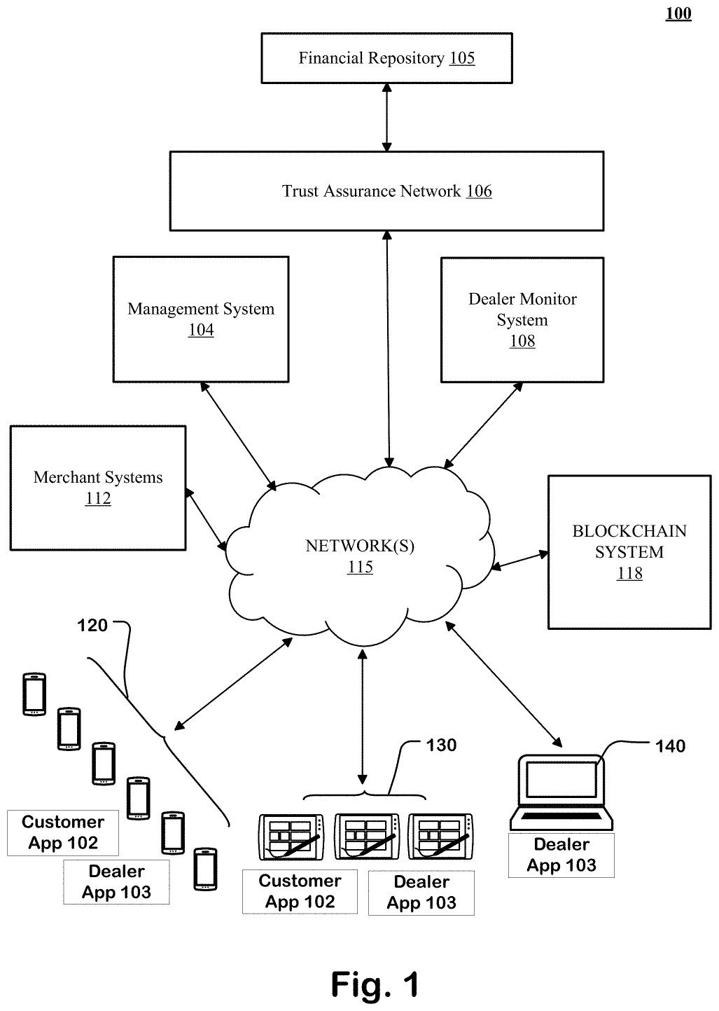

A detailed description of embodiments of the technology is provided with reference to the FIGS. 1-10.

A flexible technology platform that supports administering transactions for a gambling casino in a distributed gaming system, including selling chips and redeeming chips using a private database is described herein. The platform provides a technology executed efficiently for frequent, embedded, real-time monitoring of the experience of customers of the gaming house and the experience of the gaming house itself.

The cashless casino gaming system described herein provides a computer implemented device around gambling, many of the layers of which come together to convert the value of physical chips used at gaming tables to stable digital tokens on blockchain. The digital tokens are backed by fiat currency, also known as legal tender, whose value is backed by the government that issued it.

The system includes or has access to a financial repository, or repositories, for fiat currency, and includes or has access to a house blockchain account. The system includes procedures to declare a set of tokens and to store the tokens in trust assurance network. The system includes procedures to distribute stored cryptocurrency tokens tied to the fiat currency in the repository or repositories, and to exchange tokens in the house account for the fiat currency in the financial repository. Tokens in user accounts and in the house account, and tokens exchanged for the chips in circulation, are immutably recorded in the blockchain. The value of the tokens and chips are backed by a promise to exchange them for fiat currency, supported by the immutable records.

FIG. 1 is a network perspective of a distributed gaming system 100 for administering transactions for a gambling casino including selling chips and redeeming chips using a private database, as described herein. The network as described includes trust assurance network 106 and technical systems coupled via a network 115 such as the Internet. A plurality of network nodes are configured to execute customer app 102, dealer app 103, dealer monitor system 108 and management system 104 for back of house operations. A blockchain system 118 is utilized for transactions on a distributed ledger for transfer of tokens among wallets associated with customer apps, dealer apps, the management system and merchant systems 112. Blockchain transactions can be used to record exchanges of tokens for gambling chips, and to record exchanges of gambling chips for tokens. Also, blockchain transactions can be used to record a purchase from a merchant system, transfer of tokens in exchange for fiat currency, and for transfer of tokens to customers who purchased them. Tokens exchanged for chips or for cash can be extinguished (burned) in the blockchain. The distributed ledger is a consensus of replicated, shared, and synchronized digital data geographically spread across multiple sites, with no central administrator or centralized data storage.

As used herein, a network node is an addressable application running on a hardware device or virtual device that is attached to a network, and is capable of sending, receiving, or forwarding information over a communications channel to or from other network nodes. Examples of electronic devices which can be deployed as hardware network nodes include all varieties of computers, workstations, laptop computers, handheld computers, and smartphones. Network nodes can be implemented in a cloud-based server system. More than one virtual device configured as a network node can be implemented using a single physical device.

Trust assurance network 106 serves as a banking network buffer with an interface for transactions in banking networks, also referred to as financial repository 105. Electronic tokens are fiat backed for participants in the trust assurance network 106 who agree to rely on the banking network buffer to isolate the transactions in the trust assurance network from the banking network, and to rely on agreements to exchange tokens in the trust assurance network for cash in the banking network. The blockchain system 118 provides immutability and transparency for the participants and works to establish trust. Trust assurance network 106 maintains and tracks a strict balance of cash in one or more financial repositories, with issued tokens in circulation on the blockchain and chips in circulation among customers (and others). Security is insured via the immutability of transactions on the distributed ledger in addition to the use of a private database for tracking transactions.

In FIG. 1, system 100 comprises customer apps for multiple customers, with a node for each distinct customer. The network nodes executing the customer applications and the dealer applications can comprise smart phones 120, tablets 130, laptop or personal computers 140, and other computer systems coupled to the network 115. The system is configured for processing customer transactions and presentation and tracking of transaction history of customer events.

Management system 104 is a server side node configured to administer transactions for the gambling casino, for selling chips and redeeming chips, and includes a house account with at least one administrator wallet to track token transactions. The house account manages multiple types of accounts: the token vault to which tokens are pre-assigned when an Ethereum contract is executed, the fee wallet that collects fees charged for running the distributed gambling system, the gas fee token wallet that processes the fees paid in ETH (Ethereum) coin currency to pay for gas, a redemption wallet that processes one directional transactions of tokens to currency and an escrow wallet for holding tokens under investigation for fraud. Management system 104 maintains user accounts for customers, including customer wallets that accept messages indicating confirmation of transactions on the distributed ledger that include the customer's unique identifier, via customer app 102 API. That is, the customer's wallet tracks blockchain transactions and token balance. Additionally, customer app 102 API procedures identify and authenticate the user, in some cases storing the customer's unique QR code and providing near field communication for authenticating the user. Customer app 102 API procedures can also enable a user to request transactions with marketplaces, in some cases.

When a customer registers for the first time, a customer identification code is generated and loaded into the customer wallet after registration is complete. The customer authentication code is a QR code, in one case. Additional registration elements may be included. When the customer requests digital tokens, customer app 102 API procedures initiate the purchase of digital tokens via a credit card or a cash transaction with a teller. Tokens are transferred to the customer using the customer's unique customer identifier, also known as their blockchain address, via a blockchain transaction also serving as a recording of the cash transaction. The teller functionality of processing a credit card or cash is automated in one implementation; in another the teller is a human. The result of a successful customer transaction requesting to buy digital tokens is the transfer of fiat currency to the financial institution, and the transfer of electronic tokens to the customer wallet in the trust assurance network 106. Management system 104 is configured to administer the transactions for the casino, including selling chips and redeeming chips using a private database. Management system 104 records the transactions on a distributed ledger using crypto-tokens, including administrator wallets, each of which has a unique house identifier and private key to track transactions on the distributed ledger that include the unique house identifier.

FIG. 1 also includes dealer accounts with dealer app 103 interface that supports dealers in a gaming environment. Dealer app 103 receives and displays token to chip transactions from customer app 102 and messages for exchanging physical chips to digital tokens. Both types of transactions are recorded as blockchain transactions, as described herein. Dealer app 103 displays requested customer transactions at a gaming table and provides an interface for dealers to review and approve requested transactions. Dealer monitor system 108 displays token to chip and chip to token transactions for viewing via supervisor app by the supervisor, also referred to as pit boss, of multiple dealers in the pit on the casino floor. Management system 104 records in a private database, and can display all digital token to physical chip transactions and all physical chip to digital token transactions for all customers at the gaming tables and also the transactions conferring rewards on customers and the shopping transactions via digital tokens by customers. Management system 104 also displays rewards made available to users of customer app 102.

Customer app 102 identifies and authenticates the customer as present and ready to interact at the table, via multi-factor authentication (MFA) with some combination of multiple identifiers for the customer, such as near field communication, unique QR code and customer PIN before completing point of sale (PoS) transactions. Dealer app 103 receives a request for an electronic token transfer for physical chips for a customer at a gaming table. A verbal exchange between the dealer and the pit boss confirms the requested transaction, in some scenarios, and the customer receives physical chips in exchange for the customer electronic tokens and uses the physical chips to complete play at the casino tables. Both physical chips and digital tokens are directly usable for shopping for food and drinks and merchandise and services, in some implementations of the digital wallet. In some cases, customer app 102 also receives loyalty digital tokens, based on rules that identify transaction patterns to be rewarded. When the customer leaves the property or community, they can exchange physical chips for digital tokens, typically with a dealer using dealer app 103 at a gaming table. Customer app 102 completes a blockchain transaction transferring the digital tokens to an administrator wallet, in which the tokens correspond to actual cash units (ACUs) that have a one to one value with the fiat currency and can be exchanged for cash or credit card credit. In this scenario, the result of a successful customer transaction is that management system 104 returns to the customer the value of the customer's unused digital tokens via the transfer of ACUs, using fiat currency from the bank or via credit being issued to the customer's credit card in exchange for the digital tokens in the customer's digital wallet.

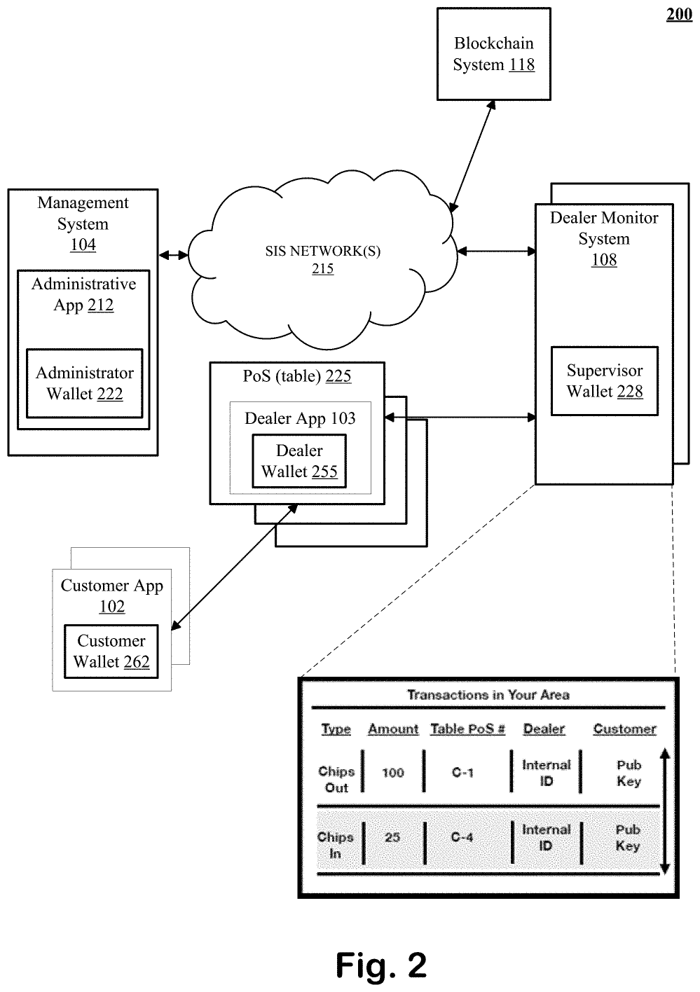

FIG. 2 illustrates system interactions that support the distributed gaming system 200 described herein. The system processes transactions on a distributed ledger, records the transaction history and records the transactions between a customer and a gaming house without using cash. Management system 104 provides tools for secure registration of supervisors via a sovereign identity system (SIS) 215. Supervisors are also referred to as pit bosses, and multiple pit bosses may be managed by a floor supervisor, in one case. Dealer app 103 at each PoS gaming table 225 is associated with a dealer account including a unique dealer identifier and private key. The dealer account can include a dealer wallet 255 for tracking transactions on the distributed ledger that include the unique dealer identifier. The unique dealer identifier is a blockchain address, in one implementation. Management system 104 includes a protocol for dealer applications on client side nodes, including a first layer authentication and authorization for a supervisor application on a client side node, and a second layer for authorization of a dealer application. The second layer delivers a verification code to a supervisor wallet 228 application, after receiving from an authorized supervisor application a request to enable a dealer application. The verification code is deliverable, outside of the network, such as verbally, to a dealer by a user of the supervisor wallet 228 application. The dealer wallet 255 application accepts the verification code input by the dealer as received from the supervisor, and in response the dealer wallet 255 application is authorized to utilize the API. In some implementations, the verification code that authorizes access is valid for only a specific period of time, such as the dealer's shift hours in one example. The supervisor first logs in to the system using supervisor log in credentials and authenticates using a password, fingerprints or other identifier. Once logged in, the supervisor uses the supervisor wallet 228 app to request authorization to enable dealers to access the system. Administrative app 212 provides verification codes to the supervisor wallet 228 app for authorized dealers. Dealer app 103 logs in to the network via the administrative app 212, using the verification code. The supervisor provides the verification codes to the dealers. The verification codes are modified regularly, and can be usable only one time, to enhance security. In one case, a dealer's verification code is updated once for each shift that they work. Dealer app 103 with dealer wallet 255 at point of sale (PoS) table 225 is usable by a dealer to confirm requests for transactions by customers via customer wallet 262 in customer app 102. Supervisor wallet 228 can be utilized to review statistics for a dealer's session and administrative app 212 can deactivate the verification code for a dealer at the end of their shift, or in another example, due to abnormal transactions being reported. Dealers can cash out tips they receive via transactions of tokens from customer wallets and dealer wallets, by utilizing the redemption wallet in some implementations.

Management system 104 manages access by the server side node to dealer account records by a supervisor application in cooperation with a supervisor account that includes supervisor account records identifying a set of dealer accounts under supervision. This includes receiving from a supervisor application a request to enable a dealer application. The protocol includes generating a verification code for the request, providing the verification code to the supervisor application in response to the request from the supervisor application to enable a particular dealer account. The verification code can be provided to a dealer. The protocol also includes receiving a login request from a dealer application to login the particular dealer account including the verification code, and in response authorizing access to dealer account records for the particular dealer account by the dealer application. These steps securely link the dealer application to the server.

Continuing the description of FIG. 2, a common transaction is to exchange electronic tokens in the customer's digital wallet for a quantity of physical chips. The dealer uses the dealer wallet 255 of dealer app 103 that tracks transactions on the distributed ledger that include the dealer's unique dealer identifier, to review transactions completed on the distributed ledger. Dealer monitor system 108 with supervisor wallet 228 of an authorized supervisor application displays a near real time rolling display of all transactions at the PoS table 225 for every dealer so the pit boss (supervisor) can monitor and review the token to chip transactions and chip to token transactions on the gambling house floor. PoS table 225 also transmits the transactions processed for each gaming table for each dealer for every customer to administrative app 212 to an administrator wallet 222 administered in management system 104, which can be monitored by the back of house floor manager. Each entry in the transaction history includes a time stamp of the time at which the transaction transpired, a table number, the customer's public key identity and the quantity in the transaction, in one implementation. Administrative app 212 displays the transaction history for all of the dealers being managed by a pit boss, and for all of the pit bosses to an identified house manager, in time sequence, in one case.

Using the disclosed distributed ledger transactions for customers, the identity of customers and of dealers and their private identity information (PII) are protected. In one case, table dealers are onboarded by employee number assigned by the company, and that resolves within their HR system. The sovereign identity system (SIS) manages codes for login to PoS and monitoring apps. Hierarchy and login control enable reporting to be accessed by only those who are securely registered.

For the distributed gaming system, a disclosed house account, with a unique house identifier and private key, records transactions on a distributed ledger using crypto-tokens. Administrator wallet 222 tracks transactions on the distributed ledger that include the unique house identifier. The distributed ledger can utilize a blockchain platform such as Ethereum™ Eris™, Multichain™, Bitcoin™, Hyperledger Fabric™, Credo Blockchain™, and Hyperledger Corda™. Customers carry digital currency around in customer wallets, with access via their mobile devices. Fiat to token transactions are recorded at back of house and token to chip and chip to token transactions are viewed by the supervisor in supervisor wallet 228 (pit boss) on the casino floor. Token to chip and chip to token transactions are recorded to administrative app 212 in administrator wallet 222 (back of house) and in a private database. An AI based bot can be utilized to analyze frames of data in the private database, and transactions on the blockchain recorded in wallets, for fraud detection across all transaction points, including the interactions between the PoS at the dealer table and the back of house actions, in one implementation. Upon detection of suspicious activity, tokens in question can be moved to an escrow wallet for the duration of the fraud investigation. The escrow wallet is entrusted with the tokens under dispute and transfer of the tokens is completed after notification that the fraud investigation is complete and transaction requirements are satisfied.

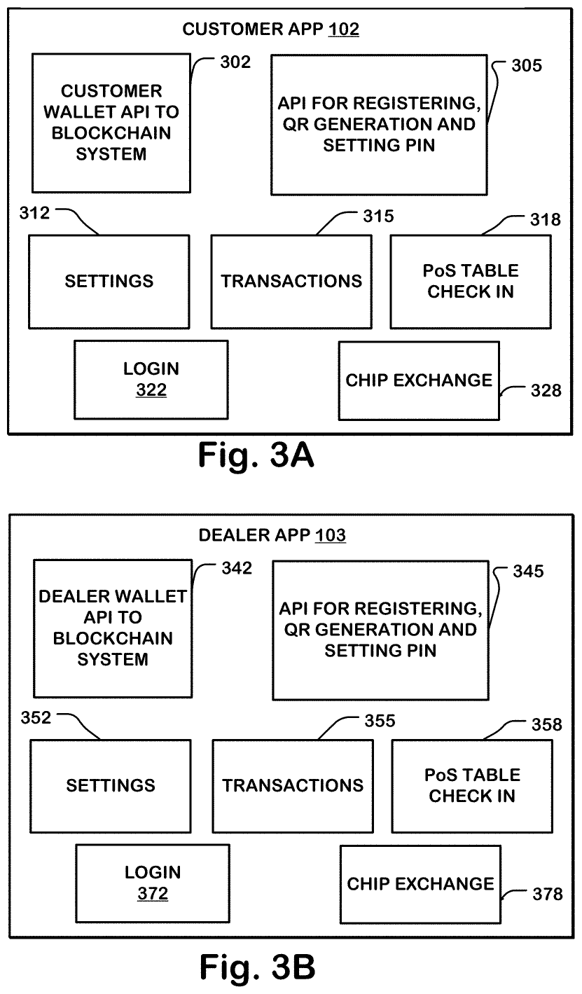

FIG. 3A shows a block diagram for customer app 102. Customer wallet API to blockchain system 302 is the interface with the distributed ledger implemented in blockchain system 118. A user account for a customer includes customer wallet 262 that tracks transactions on the distributed ledger that include the user's unique customer identifier and private key. API for registering, QR generation and setting PIN 305 provides functions for identifying a customer, confirming a customer's email and connected device, requesting and setting the user's PIN, and generating a unique QR code in some implementations. Settings 312 capture the customer's preferences for their mobile app and device. Transactions 315 includes procedures that record and track purchases, and procedures for storing transactions of fiat currency to token and digital token to fiat currency. Transactions include transfer of tokens from one of the one or more administrator wallets to the customer wallet of the user account for the particular customer, transfer of tokens from the customer wallet of the identified user account to one of the one or more administrator wallets, and transfer of tokens from the customer wallet of the identified user account to one of the one or more administrator wallets. Login 322 confirms the identity of the customer, and authenticates the customer using a password, fingerprints or other identifiers for multi-factor authentication (MFA). Chip exchange 328 authorizes the customer to make transactions at the PoS table 318, after validating the customer's PIN and other authorization criteria such as the customer's unique QR code and optionally near field communication.

FIG. 3B shows a block diagram for dealer app 103 in an embodiment described herein. Dealer wallet API to blockchain system 342 is the interface with the distributed ledger implemented in blockchain system 118. Dealer wallet 255 tracks transactions on the distributed ledger that include a unique customer identifier and private key. API for registering, QR generation and setting PIN 345 provides functions for recognizing a customer checking in at a PoS gambling table 358, confirming a customer's connected device, requesting and receiving the user's PIN, and confirming the customer's unique QR code in some implementations. Settings 352 capture the dealer's preferences for their mobile app and device. Transactions 355 procedures record and track chip transactions with customers. Login 372 confirms the identity of the dealer, and authenticates the dealer using a password, fingerprints or other identifiers for multi-factor authentication (MFA). Additionally, login 372 confirms that the verification code entered by the dealer is valid for the dealer for the current time at which the code is entered. Chip exchange 378 authorizes the dealer to make token to chip and chip to token transactions at the PoS table 225, after validating the dealer's verification code. Tokens transferred from a customer wallet 262 to a dealer wallet 255 will be aggregated at the pit-boss level in supervisor wallet 228, in one implementation.

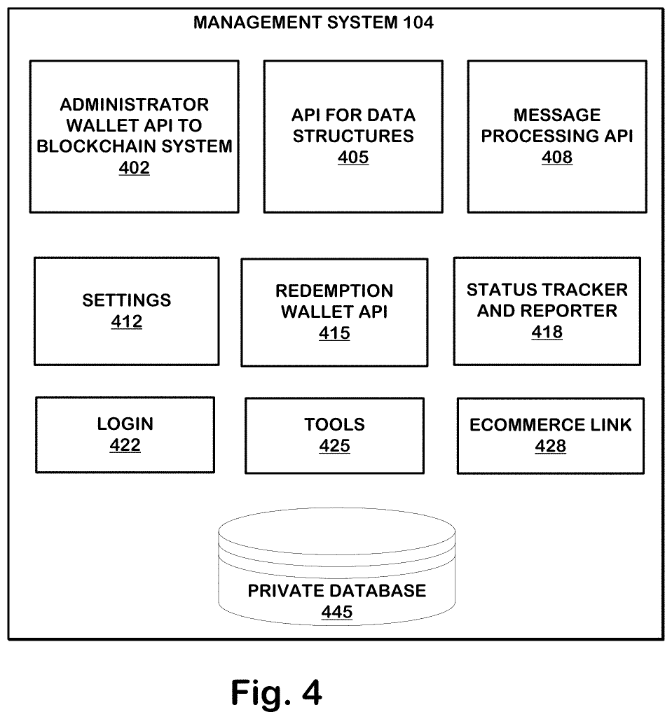

FIG. 4 shows a block diagram for management system 104 configured to administer transactions for the distributed gaming system with administrative app 212 described herein. Administrative app 212 records at least some of the transactions on a distributed ledger using crypto-tokens for a house account having a unique house identifier and private key, including at least one administrator wallet to track transactions on the distributed ledger that include the unique house identifier. Administrator wallet API to blockchain system 402 is the interface with the distributed ledger implemented in blockchain system 118. Administrator wallet 222 tracks transactions on the distributed ledger that include the unique house identifier and private key. Management system 104 also includes a settings memory 412, storing various settings for the system, operation wallets for processing gas fees for transactions. ERC20 transactions require ETH, also known as gas, to power transactions on the Ethereum blockchain network. Gas fees are processed at ETH system wallets. In one example, gas fee token wallet processes the fees paid in ETH (Ethereum) coin currency to pay for gas. The gas fee can be paid directly by the back of house, in some cases. A fee wallet can collect fees charged for running the distributed gambling system in one implementation. API for data structures 405 is used to access and update data structures that support transactions, in private database 445. Management system 104 also includes private database 445 that stores transaction data in parallel to the blockchain. Private database 445 can be a full customer resource management and accounting database in one implementation.

Management system 104 further includes message processing API 408 that accepts input messages indicating confirmation of payment by a customer and in response transfer tokens from an administrator wallet to a customer wallet. The input messages are API calls that utilize a representational state transfer (REST) API in one implementation. In one case, payment by a customer is via Stripe, a service that allows its users to accept payments online and to keep track of payments and search past payments. In another case, PayPal or Square or other payment processing APIs can be implemented. Message processing API 408 also accepts input messages indicating confirmation of delivery of chips from a dealer to a customer, and in response transfer of tokens from a customer wallet to at least one administrator wallet 222. The dealer app 103 user interface displays a confirmation requirement for the dealer to acknowledge the completion of the transfer of physical chips to a customer in exchange for electronic tokens transferred. Message processing API 408 also accepts input messages indicating confirmation of delivery of chips from a customer to a dealer, and in response transfers tokens from at least one administrator wallet 222 to a customer wallet 262. The dealer app 103 user interface displays a confirmation requirement for the dealer to acknowledge the completion of the transfer of physical chips from a customer in exchange for electronic tokens transferred to the customer. Management system 104 also includes redemption wallet API 415 that processes a one directional transaction of tokens to currency. In one example, if the distributed gaming system uses the total number of tokens in the system, then the redeemed tokens could be transferred into circulation through the token vault.

Management system 104 further includes status tracker and reporter module 418 that records the transactions on a distributed ledger using crypto-tokens for a house account having a unique house identifier and private key, tracking transactions and performance of individual customers and dealers. Status tracker and reporter module 418 maintains user accounts for customers including unique customer identifiers and private keys, utilizing customer wallets 262 that track transactions on the distributed ledger that include a unique customer identifier. The unique customer identifier is the blockchain address for the customer, in one implementation. Status tracker and reporter module 418 also maintains dealer accounts for dealers including unique dealer identifiers and private keys, utilizing dealer wallets 255 that track transactions on the distributed ledger that include a unique dealer identifier, which is the blockchain address for the dealer in one implementation. API for data structures 405 is used to access and update data structures that support the transactions.

Management system 104 also includes tools 425 for display of reports of the status for dealers and customers. Transaction reports can be displayed on a smart phone or tablet in one example, and may be utilized by a floor supervisor, pit boss or dealer to review transactions of customers using the gambling system and to review rewards earned by customers under its supervision according to game rules. Hierarchy and login control enables house reporting to be viewable from multiple perspectives, including data fields of time, supervisor, table, dealer, customer, transaction type, and transaction amount, because the data is included in the distributed ledger entries on the blockchain.

Management system 104 also includes login module 422 which supports identification of a back of house administrator, as well as authentication and authorization procedures necessary for linking to PoS table 225. Management system 104 further includes an ecommerce link 428 linking to resources for the purposes of supporting electronic commerce to obtain rewards in support of the disclosed distributed gaming system.

An example API, including procedures and parameters used for setting up a blockchain ecosystem for blockchain transactions by the customer app and the management system are described next. Master contract interface API procedures set up a smart contract on the blockchain. Ethereum platform is utilized in the example. Ethereum is based on the use of tokens. Tokens represent digital assets, as smart contracts that make use of the Ethereum blockchain. A current instance of the Ethereum master contract pairs with the sub-contract interface declaration API. A different blockchain platform can be utilized for administering transactions for the gambling casino in a distributed gaming system. Owner contract with owner address provides basic authorization control functions, thus simplifying the implementation of user permissions for the contract. The current owner of the blockchain contract can transfer control of the contract to a new owner, in one implementation. When an Ethereum contract is executed, tokens are pre-assigned to the creator, stored in a token vault which can be one of the administrator wallets of the network described herein, in one implementation. An ERC20Basic interface parameters include the total number of tokens in existence and the total number of tokens spent in sale stages. Procedures include transfer of tokens for a specified address and amount to be transferred, as tokens ‘to’, tokens ‘from’ and ‘to’ and procedures to get the balance of the specified address. The distributed gaming system utilizes standard tokens that can be irreversibly burned (destroyed). Procedures include the transfer tokens from one address to another, the ability to check the amount of tokens that an owner allowed to a spender, the ability to increase the amount of tokens that an owner allowed to a spender, and the ability to decrease the amount of tokens that an owner allowed to a spender. The spender is a customer of a casino, in one use case.

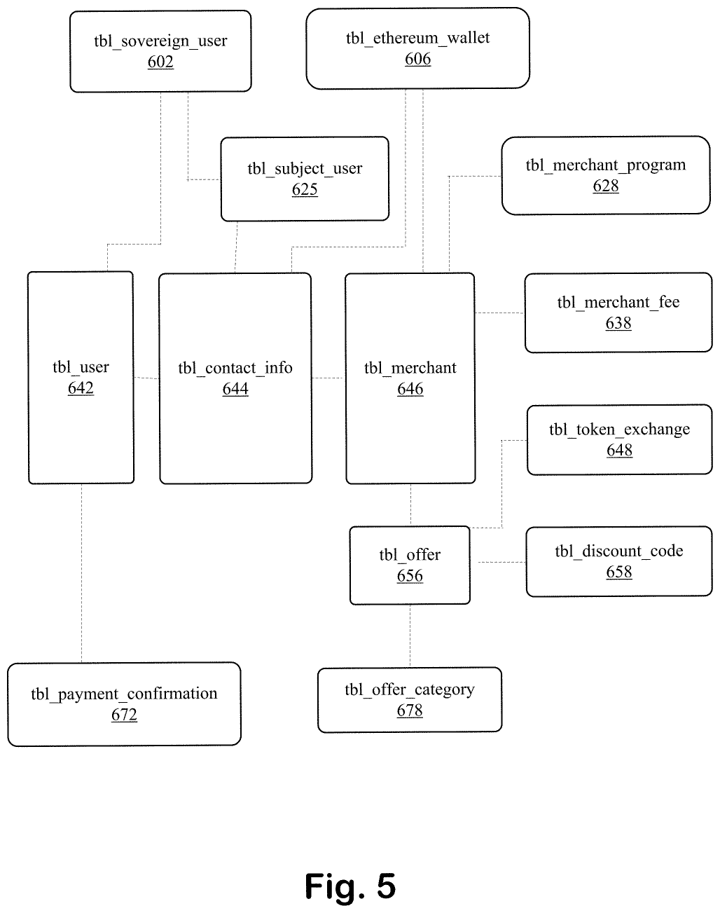

FIG. 5 constitutes a relationship diagram for an example set of data structures in a private database maintained in support of the distributed gaming system for administering transactions for a gambling casino including selling chips and redeeming chips using a private database, as described herein. The diagram shown in FIG. 5 illustrates one implementation of data structures maintained by a server application in support of the distributed gaming system described herein. Customer accounts and supervisor accounts are maintained in this structure using a sovereign table which is linked to one or more subject tables. According to this organization of the data structures, each sovereign user of the system is identified by a user table tbl_sovereign_user 602. The sovereign user is a customer or a pit boss, as described herein. In another example, the sovereign user can be a floor supervisor in the gambling system. Each customer, pit boss and any other user of the gambling system who buys tokens, such as a sponsor of the gaming system, has an account in the system that is identified in user table tbl_user 642. Detailed information for customers, pit bosses, floor managers and sponsor is stored in tbl_contact_info 644. In this example, authorization to act as a supervisor can be shared with a floor supervisor, which is in turn links to a customer account via user table tbl_user 642. A dealer is a subject user of the system, so is associated with table tbl_subject_user 625. Detailed information for dealers is also stored in tbl_contact info 644. For the system described herein, the back of house administrative app accesses a data structure labeled merchant using tbl_merchant 646, as well as tbl_merchant_program 628 that holds the name and description data for the merchant. Tbl_offer 656 holds data fields with the merchant id, name, description and details of an offer, such as the start and end date, and a notification threshold related to the number of times the offer has been utilized. Tbl_merchant_fee 638 holds fields with a merchant id and fees bases on the number of transactions, with date fields. Tbl_token_exchange 648 holds fields that identify for a user id, and offer id and discount code associated with an offer listed in tbl_offer 656. The Tbl_token_exchange 648 e relationship diagram illustrated in FIG. 5 also includes blockchain table. Tbl_discount_code 658 can map token exchanges to discount codes usable on merchant systems. Tbl_offer_category 678 can map offers in the Tbl_offer 656 to categories to offers for management purposes. Tbl_payment confirmation 672 manages confirmations of payments made by users represented in Tbl_user 642. Customers can spend tokens in the marketplace by utilizing a discount code they receive from the system or a particular merchant, and then utilizing the online ecommerce system of the merchant to make purchases.

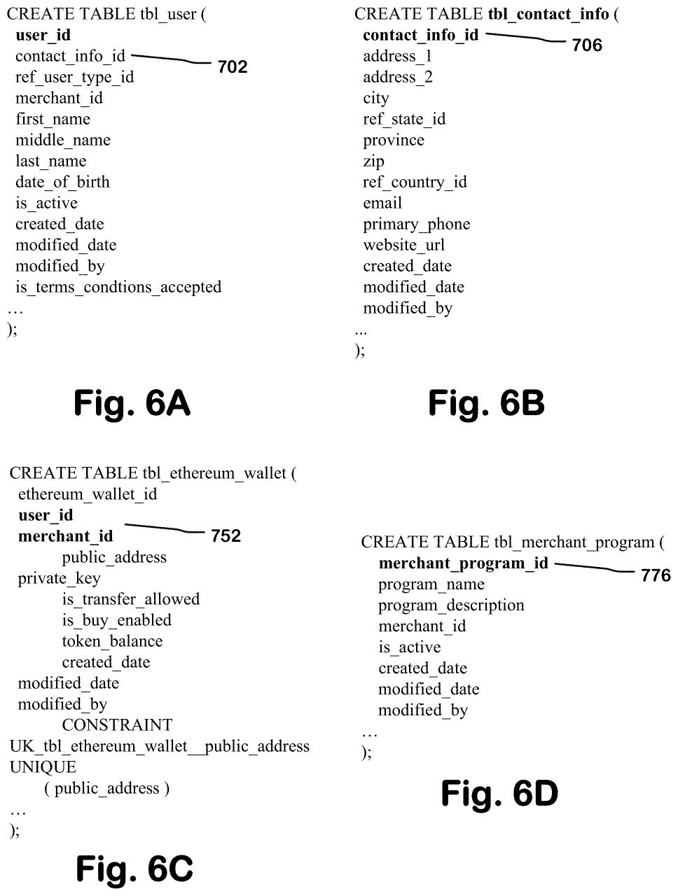

FIG. 6A through FIG. 6D illustrate the field entries for a representative subset of data structures that are utilized relative to customer apps and wallets, and pit boss apps and wallets, related as shown in FIG. 5 earlier. The database tables utilize primary keys (PK) and foreign keys (FK). FIG. 6A shows a representative set of fields for user table tbl_user 642 with primary key ‘user_id’ which links the user to the record with contact_info_id 702. FIG. 6B illustrates a representative organization of data fields for additional information about the user in tbl_contact_info 644 for a user with contact_info_id 706. FIG. 6C illustrates a representative organization for an Ethereum data structure tbl_ethereum_wallet 606 for a user with user id 752. FIG. 6D illustrates a representative organization for tbl_merchant_program 628 including a merchant_program_id 776.

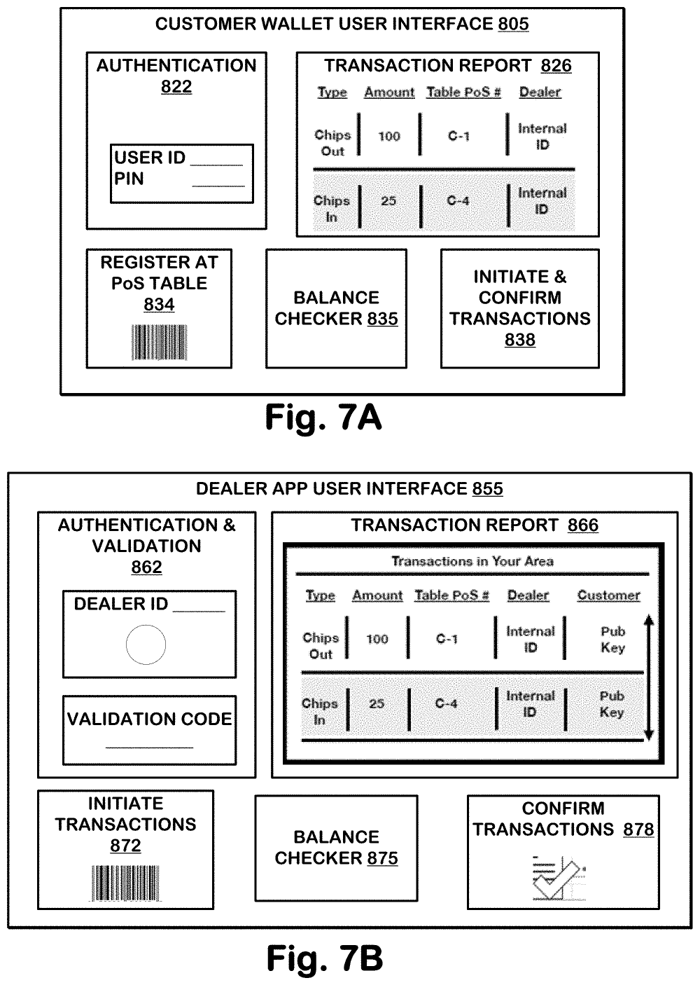

FIG. 7A shows a representative customer wallet user interface 805, that includes authentication 822 with a user ID and PIN. Additionally, register at PoS table 834 can include a bar code that the customer can use when they approach a gambling table, to register. In another implementation, near field communication can be used to identify the customer as a background action. Transaction report 826 lists transactions completed by the user. In one example, the reporting can show the type of transaction, the amount of the transaction, the table identifier for the transaction and the dealer ID. In another report date and time data can also be displayed in addition to other data. Balance checker 835 enable the user to readily check their token balance. Initiate and confirm transactions 838 enables the customer to enter a transaction request, such as a request for tokens, a request to redeem tokens for chips, and an acceptance of chips—typically from a dealer.

FIG. 7B shows a representative dealer wallet user interface 855, that includes authentication and validation 862 with a dealer ID and a validation code, typically obtained from a supervisor, as described earlier. Additionally, dealer wallet user interface 855 includes transaction report 866 for monitoring activities by customers. In one example report, customer transactions are identified using the customer's public key. Dealer wallet user interface 855 also includes initiate transactions 872 which can utilize a barcode to identify the dealer making the transaction, and balance checker 875 that the dealer can use to track the chips and tokens at their PoS table. Also, confirm transactions 878 enables the dealer to confirm the completion of transactions, such as accepting chip purchase messages indicating confirmation of delivery of chips from the dealer account to an identified user account, and accepting redemption messages indicating confirmation of delivery of chips attributed to the user account for a particular customer to the dealer's account.

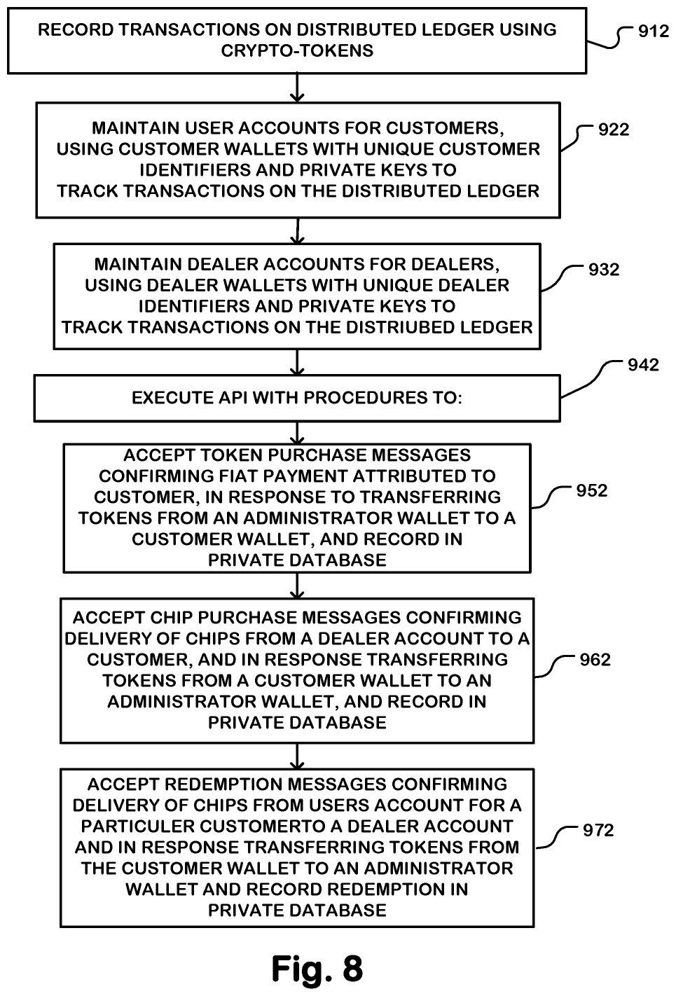

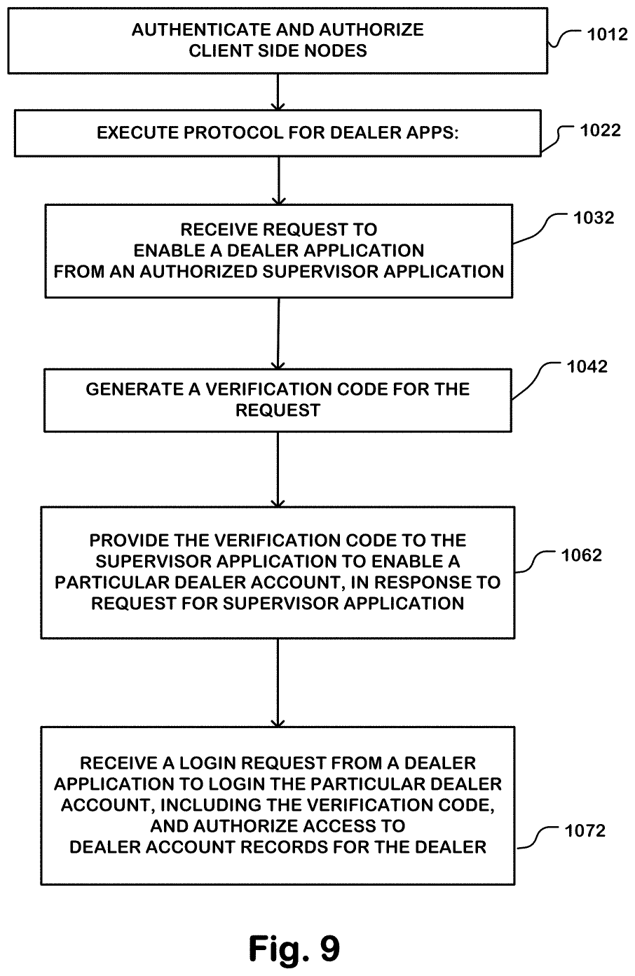

FIGS. 8 and 9 are simplified flowcharts of a procedure for administering transactions for a gambling casino in a distributed gaming system, including selling chips and redeeming chips using a private database, with the support of the server and the administrator application. In this example, the server side application records transactions on the distributed ledger using crypto-tokens (912), recording at least some of the transactions. The application includes one or more administrator wallets, each of which has a unique house identifier and private key to track transactions on the distributed ledger with unique house identifier. The server side application maintains user accounts for customers of the gaming casino, with customer wallets having unique customer identifiers and private keys to track transactions on the distributed ledger that include the unique customer identifiers (922). The server side application also maintains dealer accounts for dealers having unique dealer identifiers and private keys to track transactions on the distributed ledger that include the unique dealer identifiers (932).

The server side application executes an API (942) with distributed gaming system procedures. One procedure is accepting token purchase messages indicating confirmation of fiat payment attributed to the user account (952) for a particular customer and in response transferring tokens from an administrator wallet to a customer wallet. Another procedure is accepting chip purchase messages indicating confirmation of delivery of chips from a dealer account to an identified user account (962) and in response transferring tokens from the customer wallet of the identified user account to one of the one or more administrator wallets, and recording the purchase of chips in the private database. A third procedure is accepting redemption messages indicating confirmation of delivery of chips attributed to the user account for a particular customer to a dealer account (972) and in response transferring tokens from the customer wallet of the identified user account to one of the one or more administrator wallets and recording the redemption of chips in the private database.

FIG. 9 illustrates the flowchart for enabling supervisor apps administering transactions for a gambling casino to authenticate and authorize client side nodes (1012). The protocol for dealer applications (1022) for authentication and authorization of dealer applications on client side nodes includes receiving from an authorized supervisor application a request to enable a dealer application (1032) and generating a verification code for the request (1042). The protocol includes providing the verification code to the supervisor application in response to the request from the supervisor application to enable a particular dealer account (1062) with the verification code available to be provided to a dealer. The protocol further includes receiving a login request from a dealer application to login the particular dealer account including the verification code, and in response authorizing access to dealer account records for the particular dealer account by the dealer application (1072). The generated verification code comprises a one-time code and further comprises a time limit during which the verification code can be utilized, in some implementations.

Flowcharts illustrating procedures for administering transactions for a gambling casino in a distributed gaming system are described herein. The logic can be implemented using processors programmed using computer programs stored in memory accessible to the computer systems and executable by the processors, by dedicated logic hardware, including field programmable integrated circuits, and by combinations of dedicated logic hardware and computer programs. With all flowcharts herein, it will be appreciated that many of the steps can be combined, performed in parallel or performed in a different sequence without affecting the functions achieved. In some cases, as the reader will appreciate, a re-arrangement of steps will achieve the same results only if certain other changes are made as well. In other cases, as the reader will appreciate, a re-arrangement of steps will achieve the same results only if certain conditions are satisfied. Furthermore, it will be appreciated that the flow charts herein show only steps that are pertinent to an understanding of the invention, and it will be understood that numerous additional steps for accomplishing other functions can be performed before, after and between those shown.

The technology disclosed herein can be implemented in the context of any computer-implemented system including a database system, a multi-tenant environment, or a relational database implementation like an Oracle™ compatible database implementation, an IBM DB2 Enterprise Server™compatible relational database implementation, a MySQL™ or PostgreSQL™ compatible relational database implementation or a Microsoft SQL Server™ compatible relational database implementation or a NoSQL™ non-relational database implementation such as a Vampire™ compatible non-relational database implementation, an Apache Cassandra™ compatible non-relational database implementation, a BigTable™ compatible non-relational database implementation or an HBase™ or DynamoDB™ compatible non-relational database implementation. In addition, the technology disclosed can be implemented using different programming models like MapReduce™, bulk synchronous programming, MPI primitives, etc. or different scalable batch and stream management systems like Apache Storm™, Apache Spark™, Apache Kafka™, Apache Flink™, Truviso™, Amazon Elasticsearch Service™, Amazon Web Services™ (AWS), IBM Info-Sphere™, Borealis™, and Yahoo! S4™.

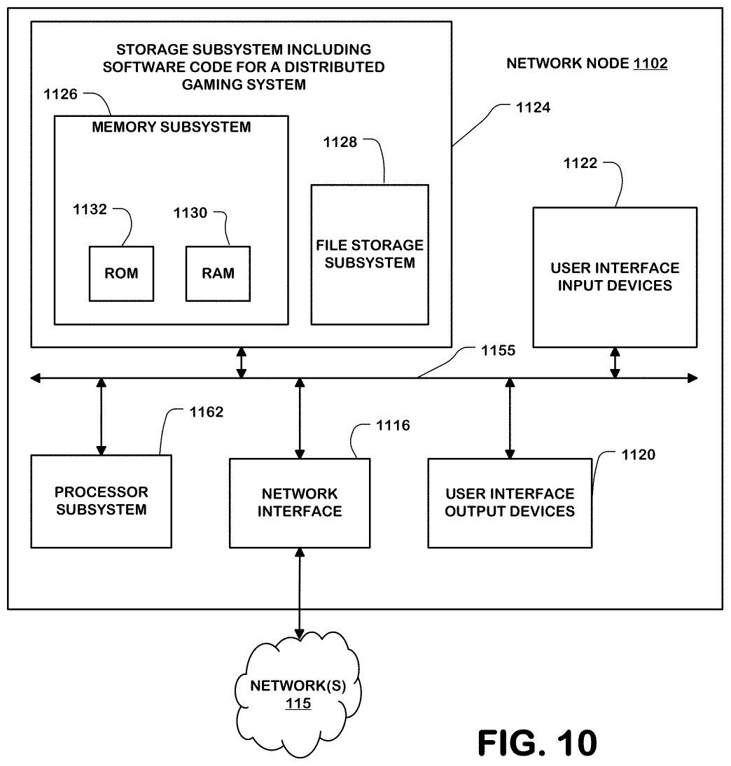

FIG. 10 is a simplified block diagram of a network node that can be used to implement management system 104, dealer monitor system 108, customer app 102, dealer app 103 and other components of the electronic system for administering transactions for a gambling casino in a distributed gaming system, described herein. The network node typically includes an operating system executed by a processor subsystem 1162 which communicates with a number of peripheral devices via bus subsystem 1155. These peripheral devices may include a storage subsystem 1124, comprising a memory subsystem 1126 and a file storage subsystem 1128, user interface input devices 1122, user interface output devices 1120, and a network interface subsystem 1116. The input and output devices allow user interaction with network node 1102. Network interface subsystem 1116 provides an interface to outside network 115 and is coupled via network 115 to other elements in a data processing system. The physical hardware components of network interfaces are sometimes referred to as network interface cards (NICs), although they need not be in the form of cards; for instance they could be in the form of integrated circuits (ICs) and connectors fitted directly onto a motherboard, or in the form of macro cells fabricated on a single integrated circuit chip with other components of the computer system.

User interface input devices 1122 may include a keyboard, pointing devices such as a mouse, trackball, touchpad, or graphics tablet, a scanner, a touchscreen incorporated into the display, audio input devices such as voice recognition systems, microphones, and other types of input devices. In general, use of the term “input device” is intended to include all possible types of devices and ways to input information into network node 1102 or onto network 115.

User interface output devices 1120 may include a display subsystem, a printer, a fax machine, or nonvisual displays such as audio output devices. The display subsystem may include a cathode ray tube (CRT), a flat panel device such as a liquid crystal display (LCD), a projection device, or some other mechanism for creating a visible image. The display subsystem may also provide a nonvisual display such as via audio output devices. In general, use of the term “output device” is intended to include all possible types of devices and ways to output information from network node to the user or to another machine or network node. In particular, an output device of the network node on which the e-book engagement system is implemented, may include a visual output informing a user of action recommendations made by the system, or may include a communication device for communicating action signals.

Storage subsystem 1124 stores the basic programming and data constructs that provide the functionality of certain embodiments of the present invention. For example, the various modules implementing the functionality of certain embodiments of the invention may be stored in storage subsystem 1124. These software modules are generally executed by processor subsystem 1162.

Memory subsystem 1126 typically includes a number of memories including a main random access memory (RAM) 1130 for storage of instructions and data during program execution and a read-only memory (ROM) 1132 in which fixed instructions are stored. File storage subsystem 1128 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer-readable medium such as one or more CD-ROMs, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed. The databases and modules implementing the functionality of certain embodiments of the invention may also be stored by file storage subsystem 1128. The host memory subsystem 1126 contains, among other things, computer instructions which, when executed by the processor subsystem 1162, cause the computer system to operate or perform functions as described herein. As used herein, processes and software that are said to run in or on “the host,” “the computer” or “the network,” execute on the processor subsystem 1162 in response to computer instructions and data in the host memory subsystem 1126 including any other local or remote storage for such instructions and data.

Bus subsystem 1155 provides a mechanism for letting the various components and subsystems of network node 1102 communicate with each other as intended. Although bus subsystem 1155 is shown schematically as a single bus, alternative embodiments of the bus subsystem may use multiple busses.

A network node can be of varying types including a personal computer, a portable computer, smart phone, tablet computer, a workstation, a computer terminal, a network computer, a television, a mainframe, a server farm, a widely-distributed set of loosely networked computers, or any other data processing system or user device. Due to the ever-changing nature of computers and networks, the description of network node depicted in FIG. 11 is intended only as a specific example for purposes of illustrating the preferred embodiments of the present invention. Many other configurations of network node are possible having more or less components than the system depicted in FIG. 11.

In some embodiments, in addition, one or more of the server application, the supervisor application, and the reader application can be implemented in the network node as a Software-as-a-Service (SaaS) application, a web-architected application or a cloud-delivered service. Examples of common SaaS applications today include Salesforce.com™, Box™Dropbox™, Google Apps™, Amazon Web Services AWS™, Microsoft Office 365™, Workday™, Oracle on Demand™, Taleo™, Yammer™, and Concur™. SaaS applications provide functionalities to users that are implemented in the cloud, and that are the target of policies, e.g., logging in, editing user information, updating whitelists, deleting contacts from the contact list, in contrast to the offerings of simple websites and e-commerce sites. Note that a SaaS application can be supported by both web browser clients and application clients that use URL-based APIs (application programming interfaces).

Disclosed technology for managing transactions between a customer and a gaming house without using cash utilizes blockchain transactions enabling a management application to facilitate purchase of digital tokens by the customer using a credit card or cash and providing the digital tokens via blockchain transaction. Also included is receiving a request from the customer, at a PoS table, for chips in exchange for tokens and exchanging the tokens for chips using a blockchain transaction. Further disclosed is exchanging a quantity of physical chips for digital tokens and exchanging the digital tokens for fiat currency via a blockchain transaction.

Other implementations of the method described in this section can include a non-transitory computer readable storage medium storing instructions executable by a processor to perform any of the methods described above. Yet another implementation of the method described in this section can include a system including memory and one or more processors operable to execute instructions, stored in the memory, to perform any of the methods described above.

Any data structures and code described or referenced above are stored according to many implementations on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The system delivers tokens to customers using a blockchain transfer from trust assurance network blockchain account. The system includes procedures to deliver tokens to customers, using a blockchain transaction. The system also includes procedures to use a blockchain transaction to exchange tokens for chips, and to extinguish tokens exchanged for the chips. The system further includes procedures to transfer tokens to the house blockchain account using a blockchain transaction, such as for chips “lost” by a customer in a game.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A distributed gaming system, comprising:
a server side node or nodes, including one or more data processor, configured to administer transactions for a gambling casino including selling chips and redeeming chips using a private database, a distributed ledger and a declared set of tokens, the set of tokens being fiat-backed;
to maintain a plurality of administrator wallets, at least one of the administrator wallets in the plurality of administrator wallets having a unique house identifier and private key to track transactions on the distributed ledger that include the unique house identifier, the plurality of administrator wallets including a token vault, and a one directional redemption wallet wherein tokens transferred to the one directional redemption wallet are withdrawn from circulation in the distributed ledger;
to maintain user accounts for customers, including customer wallets having unique customer identifiers and private keys to track transactions on the distributed ledger that include the unique customer identifiers;
to maintain dealer accounts for dealers; and
to execute an application program interface (abbreviated API) with client side nodes, the API having procedures:
to accept token purchase messages indicating confirmation of fiat payment attributed to the user account for a particular customer and in response transfer tokens which are members of the set of tokens from the token vault to the customer wallet of the user account for the particular customer on the distributed ledger, and record the token purchase in the private database;
to accept chip purchase messages indicating confirmation of delivery of chips from a dealer account to an identified user account, and in response transfer tokens which are members of the set of tokens from the customer wallet of the identified user account to the one directional redemption wallet, and record the purchase of chips in the private database; and
to accept chip redemption messages indicating confirmation of delivery of chips attributed to the user account for a particular customer to a dealer account, and in response transfer tokens which are members of the set of tokens from one of the administrator wallets in the plurality of administrator wallets to the customer wallet of the identified user account on the distributed ledger, and record the redemption of chips in the private database.

2. The system of claim 1, wherein the one or more administrator wallets include dealer wallets having unique dealer identifiers and private keys to track transactions of tokens in the set of tokens on the distributed ledger that include the unique dealer identifiers.

3. The system of claim 1, wherein the data processor or data processors of the server side node include logic for authentication and authorization of client side nodes, including a first protocol for customer applications on client side nodes, and a second protocol for dealer applications on client side nodes.

4. The system of claim 3, wherein the second protocol for dealer applications includes
receiving from an authorized supervisor application a request to enable a dealer application;
generating a verification code for the request;
providing the verification code to the supervisor application in response to the request from the supervisor application to enable a particular dealer account, wherein the verification code can be provided to a dealer; and
receiving a login request from a dealer application to login the particular dealer account including the verification code, and in response authorizing access to dealer account records for the particular dealer account by the dealer application.

5. The system of claim 4, wherein generating a verification code further comprises generating a one-time code.

6. The system of claim 4, wherein the verification code further comprises a time limit during which the verification code can be utilized.

7. The system of claim 1, wherein the tokens which are members of the set of tokens are assigned to the token vault when declared upon confirmation of deposit of fiat payment in one or more financial repositories, and including maintaining in coordination with one or more administrator wallets and the redemption wallet a balance of tokens which are members of the set of tokens, currency delivered in response to transfer of tokens which are members of the set of tokens to the redemption wallet and chips delivered in response transfer of tokens which are members of the set of tokens to the redemption wallet.

8. The system of claim 1, wherein the one or more administrator wallets includes an escrow wallet configured for tokens which are members of the set of tokens subject to a fraud investigation.

9. A non-transitory computer readable memory storing computer instructions for administering transactions for a gambling casino in a distributed gaming system, including selling chips and redeeming chips using a private database, a distributed ledger and a declared set of tokens, the set of tokens being fiat-backed, comprising:
maintaining a plurality of administrator wallets, at least one of the administrator wallets in the plurality of administrator wallets having a unique house identifier and private key to track transactions on the distributed ledger that include the unique house identifier, the plurality of administrator wallets including a token vault, and a one directional redemption wallet wherein tokens transferred to the one directional redemption wallet are withdrawn from circulation in the distributed ledger;
maintaining user accounts for customers, including customer wallets having unique customer identifiers and private keys to track transactions on the distributed ledger that include the unique customer identifiers;
maintaining dealer accounts for dealers; and
executing an application program interface (abbreviated API) with client side nodes, the API having procedures:
accepting token purchase messages indicating confirmation of fiat payment attributed to the user account for a particular customer and in response transferring tokens which are members of the set of tokens from the token vault to a customer wallet on the distributed ledger;
accepting chip purchase messages indicating confirmation of delivery of chips from a dealer account to an identified user account, and in response transferring tokens which are members of the set of tokens from the customer wallet of the identified user account to the one directional redemption wallet, and recording the purchase of chips in the private database; and
accepting chip redemption messages indicating confirmation of delivery of chips attributed to the user account for a particular customer to a dealer account, and in response transferring tokens which are members of the set of tokens from one of the administrator wallets in the plurality of administrator wallets to the customer wallet of the identified user account on the distributed ledger, and recording the redemption of chips in the private database.

10. The non-transitory computer readable memory of claim 9, wherein the one or more administrator wallets include dealer wallets having unique dealer identifiers and private keys to track transactions on the distributed ledger that include the unique dealer identifiers.

11. The non-transitory computer readable memory of claim 9, wherein the computer instructions for administering transactions include logic for authentication and authorization of client side nodes, including a first protocol for customer applications on client side nodes, and a second protocol for dealer applications on client side nodes.

12. The non-transitory computer readable memory of claim 11, wherein the second protocol for dealer applications includes
receiving from an authorized supervisor application a request to enable a dealer application;
generating a verification code for the request;
providing the verification code to the supervisor application in response to the request from the supervisor application to enable a particular dealer account, wherein the verification code can be provided to a dealer; and
receiving a login request from a dealer application to login the particular dealer account including the verification code, and in response authorizing access to dealer account records for the particular dealer account by the dealer application.

13. The non-transitory computer readable memory of claim 12, wherein generating a verification code further comprises generating a one-time code.

14. The non-transitory computer readable memory of claim 12, wherein the verification code further comprises a time limit during which the verification code can be utilized.

15. The non-transitory computer readable memory of claim 9, wherein the tokens which are members of the set of tokens are assigned to the token vault when declared upon confirmation of deposit of fiat payment in one or more financial repositories, and including maintaining in coordination with the one or more administrator wallets and the redemption wallet a balance of tokens which are members of the set of tokens, currency delivered in response to transfer of tokens which are members of the set of tokens to the redemption wallet and chips delivered in response transfer of tokens which are members of the set of tokens to the redemption wallet.

16. The non-transitory computer readable memory of claim 9, wherein the one or more administrator wallets includes an escrow wallet configured for tokens subject which are members of the set of tokens to a fraud investigation.

17. A method of administering transactions for a gambling casino in a distributed gaming system, including selling chips and redeeming chips using a private database, a distributed ledger and a declared set of tokens, the set of tokens being fiat-backed, comprising:
maintaining a plurality of administrator wallets, at least one of the administrator wallets in the plurality of administrator wallets having a unique house identifier and private key to track transactions on the distributed ledger that include the unique house identifier, the plurality of administrator wallets including a one directional redemption wallet wherein tokens transferred to the one directional redemption wallet are withdrawn from circulation in the distributed ledger;
maintaining user accounts for customers including customer wallets having unique customer identifiers and private keys to track transactions on the distributed ledger that include the unique customer identifiers;
maintaining dealer accounts for dealers; and
executing an application program interface (abbreviated API) with client side nodes, the API having procedures:
accepting token purchase messages indicating confirmation of fiat payment attributed to the user account for a particular customer and in response transferring tokens which are members of the set of tokens from an administrator wallet to a customer wallet on the distributed ledger;
accepting chip purchase messages indicating confirmation of delivery of chips from a dealer account to an identified user account, and in response transferring tokens which are members of the set of tokens from the customer wallet of the identified user account to the one directional redemption wallet, and recording the purchase of chips in the private database; and
accepting chip redemption messages indicating confirmation of delivery of chips attributed to the user account for a particular customer to a dealer account, and in response transferring tokens which are members of the set of tokens from one of the one or more administrator wallets to the customer wallet of the identified user account on the distributed ledger, and recording the redemption of chips in the private database.

18. The method of claim 17, wherein the one or more administrator wallets include dealer wallets having unique dealer identifiers and private keys to track transactions on the distributed ledger that include the unique dealer identifiers.

19. The method of claim 17, further including logic for authentication and authorization of client side nodes, including a first protocol for customer applications on client side nodes, and a second protocol for dealer applications on client side nodes.

20. The method of claim 19, wherein the second protocol for dealer applications includes
receiving from an authorized supervisor application a request to enable a dealer application;
generating a verification code for the request;
providing the verification code to the supervisor application in response to the request from the supervisor application to enable a particular dealer account, wherein the verification code can be provided to a dealer; and
receiving a login request from a dealer application to login the particular dealer account including the verification code, and in response authorizing access to dealer account records for the particular dealer account by the dealer application.

21. The method of claim 20, wherein generating a verification code further comprises generating a one-time code.

22. The method of claim 17, wherein the verification code further comprises a time limit during which the verification code can be utilized.

23. The method of claim 17, wherein the tokens which are members of the set of tokens are assigned to the token vault when declared upon confirmation of deposit of fiat payment in one or more financial repositories, and including maintaining in coordination with the one or more administrator wallets and the redemption wallet a balance of tokens which are members of the set of tokens, currency delivered in response to transfer of tokens which are members of the set of tokens to the redemption wallet and chips delivered in response transfer of tokens which are members of the set of tokens to the redemption wallet.

24. The method of claim 17, wherein the one or more administrator wallets includes an escrow wallet configured for tokens which are members of the set of tokens subject to a fraud investigation.
